(19) United States
(12) Patent Application Publication
(10) Pub. No.: US 2015/0015109 A1
(43) Pub. Date: Jan. 15, 2015

(54) SPINDLE MOTOR AND HARD DISK DRIVE

(71) Applicant: MINEBEA CO., LTD., Kitasaku-gun (JP)

(72) Inventor: Akihiko SUZUKI, Kitasaku-gun (JP)

(21) Appl. No.: 14/327,095

(22) Filed: Jul. 9, 2014

(30) Foreign Application Priority Data
Jul. 12, 2013 (JP) 2013-147024

(51) Int. Cl. C23C 18/18; C23C 18/34; C23C 18/36; H02K 1/06; C23C 18/16

(52) U.S. Cl. CPC C23C 18/1848; H02K 1/06; C23C 18/1637; C23C 18/36; C23C 18/34
USPC 310/179; 427/438; 427/309

(57) ABSTRACT

A spindle motor is provided in which the scattering of contaminating particles are prevented in a stainless steel part used therein. so that a hard disk drive can be prevented from being damaged due to collision between the particles adhered on a magnetic disk surface and a magnetic head. The spindle motor has a fixed portion and a rotating portion in which at least a part of one of the fixed portion and the rotating portion is made of stainless steel, and a metallic film is directly formed on the surface of the stainless steel by electroless nickel plating.

### TECHNICAL FIELD

The present invention relates to a spindle motor having parts with a metallic film formed on the surface of stainless steel, and relates to a hard disk drive in which the spindle motor is used.

### BACKGROUND ART

Usually, since high dimensional accuracy is required for a part used in a hard disk drive, the part must have superior precision in the shape. In particular, cutting work is one of the frequently used metalworking method, and in order to improve cutting performance, sulfur (S), lead (Pb), tellurium (Te), selenium (Se) or the like is added to stainless steel as a free-cutting element. However, sulfur and lead added to improve cutting performance may generate corrosive gas, or may generate dust as contaminating particles inside the hard disk drive, thereby causing problems in use.

As a technique to maintain a degree of cleanliness in a hard disk drive, a technique is known in which electroless nickel plating is performed on a stainless steel rotor hub or shaft, except for the part attaching a bearing at which high dimensional accuracy is required (See Patent Document 1 below). However, there is a problem in that the adhesion of electroless nickel plating film to stainless steel surface is very poor since stainless steel has a passivation film for imparting corrosion resistance on the surface. Furthermore, in Patent Document 1, the application of electroless nickel plating is disclosed; however, the specific method is not disclosed, and therefore, it is not clear whether or not the adhesion of the film is sufficient.

As a technique to improve such adhesion, a technique is known in which strike plating (electrolytic nickel plating) by a Wood's nickel strike bath is performed on a disk holding member (rotor hub) and then an electroless nickel plating layer is formed (See Patent Document 2 below). The plating film formed by such method consists of a two-layer structure, that is, a primary layer formed by the electrolytic nickel plating and an electroless nickel plating layer.

However, in the electrolytic nickel plating by using the Wood's nickel strike bath as disclosed in Patent Document 2, contact points on the part are needed for applying current. Therefore, the strike plating film is not formed on the contact points, and the surface of the stainless steel material remains exposed. In a subsequent electroless nickel plating treatment, the electroless nickel plating film is not formed on the contact points, or is formed with poor adherence. As a result, since the surface of the stainless steel is exposed where the electroless nickel plating film is not formed, contaminating particles may be generated therefrom. On the other hand, when the adherence of the electroless nickel plating film is poor, metallic film of the part having low adherence may be separated in the motor. The separated piece of film becomes a contaminating material, and may cause failure during the operation of the hard disk drive. Therefore, the electroless nickel plating film must have a superior adherence over the entire plated area. However, the technique shown in Patent Document 2 cannot totally guarantee this feature.

In addition, according to the method shown in Patent Document 2, since equipment for electrolytic nickel plating is necessary in addition to equipment for electroless nickel plating, production cost may increase due to the equipment cost and additional processes.

The Patent Documents are as follows:

Patent Document 1: Japanese Unexamined Patent Application Publication No. Hei11(1999)-159536

Patent Document 2: Japanese Unexamined Patent Application Publication No. 2002-153015

### SUMMARY OF THE INVENTION

The present invention was conceived in view of the above problems, and an object of the invention is to provide a spindle motor in which scattering of contaminating particles are prevented. This object is achieved by completely covering machine-processed portions of the stainless steel part used in the spindle motor, at which free-cutting stainless steel base material is exposed, with a metallic film formed by electroless nickel plating. By this way, a hard disk drive can be prevented from being damaged due to problems such as an impact between particles adhered on magnetic disk surface and the magnetic head.

The spindle motor according to an embodiment of the present invention includes a fixed portion and a rotating portion, in which at least a part of one of the fixed portion and the rotating portion is made of stainless steel, and metallic film is directly formed on the surface of the stainless steel by electroless nickel plating.

Furthermore, in the spindle motor according to an embodiment of the present invention, the metallic film formed by the electroless nickel plating is preferably a one-layer structure containing phosphorus (P) or boron (B). In addition, it is desirable that electroless nickel plating be applied on at least one of a rotor hub and a shaft.

The hard disk drive according to an embodiment of the present invention includes the above spindle motor.

The method according to an embodiment of the present invention for producing a stainless steel part having electroless nickel plating on the surface at least includes an acid activation step and an electroless nickel plating step, in which the electroless nickel plating step is performed subsequent to the acid activation step, without washing the part.

Furthermore, in the method for producing a stainless steel part having electroless nickel plating on the surface, the method may include an acid electrolysis step before the acid activation step. The concentration of the acid solution in the acid electrolysis step is preferably higher than the concentration of the acid solution in the subsequent acid activation process

The spindle motor according to an embodiment of the present invention prevents the scattering of contaminating particles by completely covering machine processed portions of the stainless steel part used in the spindle motor, at which free-cutting stainless steel base material is exposed, with the metallic film by the electroless nickel plating. Consequently, a hard disk drive using such spindle motor can be prevented from being damaged due to problems such as impact between particles adhered on magnetic disk surface and the magnetic head.

Furthermore, by the method according to the present invention for producing a stainless steel part having electroless nickel plating on the surface, it is possible to produce a stainless steel part having an electroless nickel plating film formed over the entire surface with superior adherence since the strike plating process requiring electric contact points is eliminated. In addition, due to elimination of the strike plating process, an electrolysis plating tank, washing tank, treating agent and the like which have been used in the strike plating are no longer needed, and thus, the effects on the environment are reduced. Furthermore, since variation in film thickness is small, dimensional accuracy of the parts is improved. It should be noted that the method according to the present invention for production of stainless steel parts having electroless nickel plating on the surface is not limited to the parts of hard disk drive and can be applied to any parts that can be treated by electroless nickel plating.

### BRIEF DESCRIPTION OF DRAWINGS

FIG. 1 is a cross sectional view schematically showing the surface of a part made of stainless steel according to an embodiment of the present invention.

FIG. 2 is a cross sectional view schematically showing the surface of a conventional part made of stainless steel and having strike plating film.

FIG. 3 is a schematic flow diagram showing each of processes of electroless nickel plating according to an embodiment of the present invention,

FIG. 4 is a schematic flow diagram showing each of processes of electroless nickel plating according to another embodiment of the present invention.

FIG. 5 is a cross sectional view showing an example of structure of spindle motor according to an embodiment of the present invention.

### BEST MODE FOR CARRYING OUT THE INVENTION

### Problems in a Conventional Plating Method

Since stainless steel has a passivation film on the surface, adhesion of plating film is poor when electroless nickel plating is performed after ordinary degreasing treatment and washing treatment. This is because metal-to-metal bond between the stainless steel material and the plating film is interfered by the passivation film. Therefore, in a conventional process of electroless nickel plating applied to the stainless steel, nickel strike plating treatment is performed prior to the electroless nickel plating in order to improve adherence. During nickel strike plating treatment, a thin plating film of nickel is formed while removing passivation film. As shown in FIG. 2, according to the above conventional process, strike plating film 103 is previously formed on stainless steel base material 101, and then electroless nickel plating film 102 is formed thereon. That is, the conventional electroless nickel plating film consists of two layers.

This nickel strike plating process is a treatment in which stainless steel is immersed in a strike plating bath (Wood's nickel strike bath) containing nickel chloride and hydrochloric acid in order to remove passivation film and activate the surface, and simultaneously to deposit nickel on stainless steel surface by applying electric voltage. As a result, thin plating film of nickel having thickness of 0.5 micron or less is formed. However, this strike plating treatment requires electric contact point s(electrodes) on the stainless steel to apply voltage, and there is a problem that plating film is not formed on the contact points. Furthermore, in this strike plating treatment, high level control is needed to maintain a specified thickness of the film and its adherence.

In order to solve the above problem, the inventors have considered the use of acid activation treatment instead of the conventional nickel strike plating treatment, as a means to remove passivation film on the surface of the stainless steel. However, washing process is ordinarily performed after the acid activation treatment. If washing process is performed, passivation film is formed again on the surface of the stainless steel, and there is a problem that electroless nickel plating layer cannot be formed uniformly.

### First Embodiment

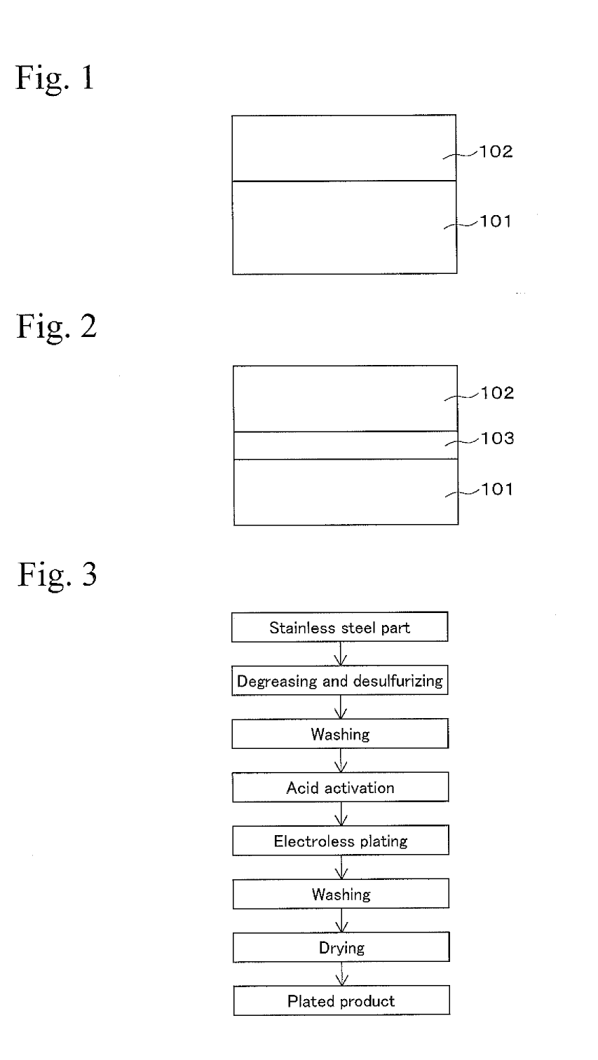

In order to perform electroless nickel plating on stainless steel parts of a spindle motor, the inventors have found that the structure as shown in FIG. 1, in which electroless nickel plating layer 102 is directly formed on the surface of the stainless steel 101 can be obtained by the method as shown in FIG. 3, that is, after performing degreasing and desulfurizing treatment, washing, and acid activation treatment in this order, stainless steel is immersed in an electroless nickel plating bath so as to perform electroless nickel plating, under conditions in which the ordinary washing process is omitted, and liquid on the surface is removed before immersion merely to avoid dripping.

Accordingly, the method for producing a stainless steel part having electroless nickel plating on the surface according to the First Embodiment of the present invention includes at least an acid activation process, and an electroless nickel plating process performed immediately after the acid activation process, without washing the part. By using the above method for producing a stainless steel part having electroless nickel plating on the surface, electroless nickel plating film having superior adherence can be formed over the entire surface of the stainless steel part because the strike plating requiring electrical contact points is eliminated. In addition, since the strike plating process is omitted, the electrolytic plating tank, washing tank, treating agent and the like which have been used for this treatment are no longer needed, reducing the effects on the environment. Also, variation in film thickness is reduced, and dimensional accuracy of the part is improved.

### Second Embodiment

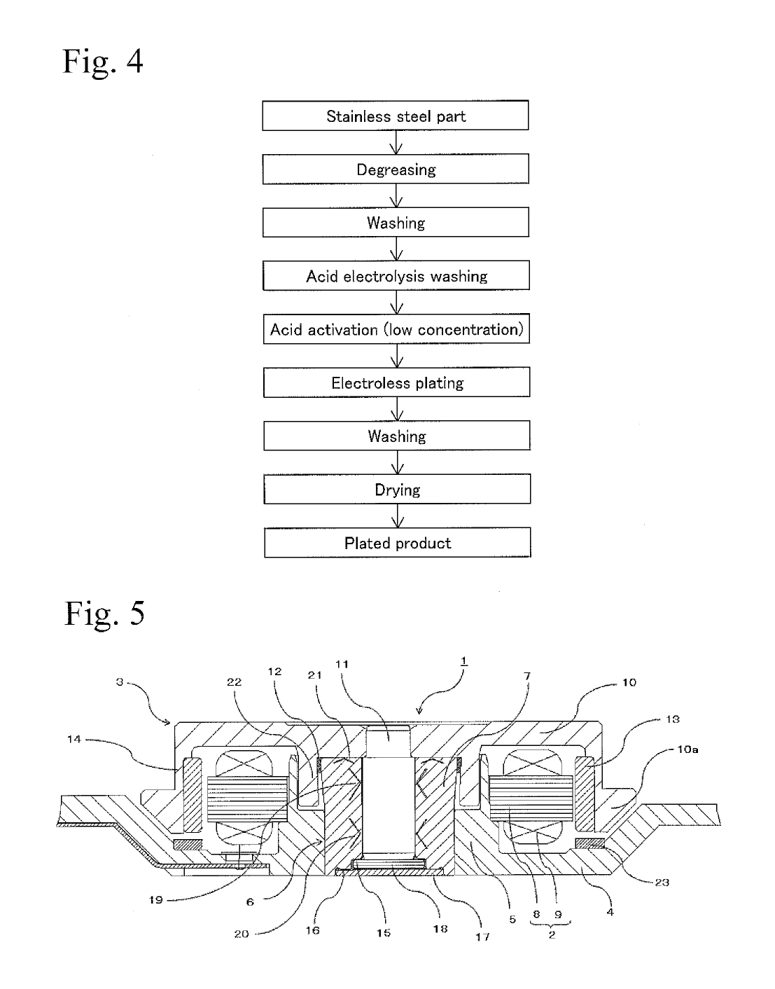

The method according to the Second Embodiment of the present invention is shown in the flow diagram of FIG. 4. That is, as shown in FIG. 4, (1) after obtaining a part made of stainless steel by a machining process or the like, (2) only degreasing treatment is performed on this part (degreasing and desulfurizing are performed in the First Embodiment), and (3) acid electrolysis treatment is performed so as to remove oxidized film on the surface of the stainless steel. In this acid electrolysis treatment, desulfurizing can also be performed.

After removing the oxidized film, washing is not performed, as in the First Embodiment, and (4) acid activation treatment is performed. In the Second Embodiment, the treatment solution used in the acid activation treatment has an acid concentration lower than that of the treatment solution of the acid electrolysis treatment (and lower than that of the acid activation treatment in the First Embodiment). By preparing the acid activation treatment solution with lower acid concentration than that of the acid electrolysis treatment solution of the Second Embodiment or the acid activation treatment solution of the First Embodiment, the amount of acid that may be carried to the plating solution of the subsequent electroless plating step can be reduced. After the acid activation, washing is omitted in a manner similar to that in the First Embodiment, electroless nickel plating treatment is performed, washing and drying are performed and a part made of stainless steel having nickel plating on the surface thereof is obtained.

As explained, the characteristic of the Second Embodiment is that after only degreasing treatment is performed, instead of degreasing and desulfurizing of the First Embodiment, acid electrolysis washing treatment by cathode method is performed, followed by acid activation treatment at a lower acid concentration.

In summary, the acid electrolysis washing treatment is as follows. An acid aqueous solution is used as a washing solution. Sulfuric acid and hydrochloric acid may be mentioned as the acid. For example, an aqueous hydrochloric acid solution can be used. Here, a stainless steel part in the solution functions as a cathode, and an anode is immersed in the same solution facing the stainless steel part. When voltage is applied, hydrogen ions are selectively conducted to the stainless steel part, and surface contamination and oxidized film are removed by hydrogen gas generated by electrons that moved from the anode. On the other hand, chloride anions, which cause corrosion of stainless steel, gather at the anode, and they are eliminated as chlorine gas by losing electrons.

An oxidized film formed on the surface of the stainless steel is removed by the strong reducing power of hydrogen gas. At the same time, sulfur or the like, which is contained in steel as an inclusion, is removed. Therefore, during the degreasing process, which is the process immediately before, sodium permanganate necessary for desulfurizing is no longer necessary. Therefore, the impact on the environment can be reduced.

Furthermore, since chloride anions are attracted to the anode, development of corrosion on the surface of the stainless steel can be prevented, and contamination of the aqueous hydrochloric acid solution or plating solution in the subsequent processes caused by the corroded material can be reduced. During the acid electrolysis washing process, since only removal of oxidized film and inclusions is performed, and a clean metal surface is exposed, the adhesion in subsequent electroless plating processes is improved.

After the acid electrolysis washing treatment, the acid activation treatment is performed with an acid aqueous solution in which acid concentration is lower than that of the washing solution of the acid electrolysis washing. Since concentration of acid is prepared at a lower level in the acid activation treatment, the amount of acid that is brought into the electroless plating solution in the subsequent process can be reduced compared to the First Embodiment, and the adhesion of electroless plating layer can be improved.

### Example of Application of Plating Method According to the Invention

The spindle motor according to an embodiment of the present invention is an example where the method for producing the part made of stainless steel having the above-mentioned electroless nickel plating on the surface can be appropriately applied. The spindle motor includes a fixed portion and a rotating portion, and at least one of the fixed portion and the rotating portion includes a part made of stainless steel with a metallic film directly formed on the surface of the stainless steel by electroless nickel plating. That is, a single layer of electroless nickel plating layer is directly formed on the surface of the stainless steel without having an intervening strike plating layer. Such a spindle motor can be appropriately arranged in a hard disk drive.

According to the spindle motor having such a structure, contaminating particles can be prevented from being scattered because, the stainless steel parts used in the spindle motor have the machine processed portions exposing free-cutting stainless steel base material completely covered by the metallic film formed by electroless nickel plating. Therefore, a hard disk drive can be prevented from being damaged due to problems such as impact between the particles adhered on a magnetic disk surface and the magnetic head.

The electroless nickel plating according to an embodiment of the present invention includes electroless plating that forms a substantial nickel film or a metallic film containing nickel as a main component, and includes electroless plating with nickel alloy. As a main element contained in addition to nickel, phosphorus (P), boron (B), cobalt (Co), iron (Fe), tungsten (W), copper (Cu) or the like can be mentioned. As an electroless plating combining above elements with nickel, Ni—P plating, Ni—B plating, Ni—P—B plating, Ni—Co alloy plating, Ni—Co—P alloy plating, Ni—Fe—P alloy plating, Ni—W—P alloy plating, Ni—Co—W—P alloy plating, Ni—Cu—P alloy plating or the like can be mentioned. Furthermore, as a reducing agent of electroless nickel plating, hypophosphite, sodium borohydride, hydrazine or the like can be used. It should be noted that since the strike plating layer, which is a conventional technique, generally does not contain phosphorus, a metallic film formed by electroless nickel plating according to the present invention can be identified by detecting phosphorus (P) or boron (B) dispersed in the entirety of the plating layer.

As a part made of stainless steel to which electroless nickel plating of the present invention is applied, a rotor hub, axial part, sleeve or the like can be mentioned. Furthermore, as a stainless steel used in the present invention, DHS1, SUS416, SUS410F2, SUS420F, and SUS430F can be mentioned.

Next, the Embodiment of the spindle motor according to an embodiment of the present invention is explained with reference to FIG. 4. FIG. 4 is a cross sectional view showing an example of the structure of the spindle motor of the present invention. As shown in FIG. 4, the spindle motor 1 is used as a motor for driving a data recording device having magnetic disks, optical disks or the like used in a computer. In total, it is constructed by a stator assembly (hereinafter referred to as “assy”) 2 (fixed portion) and a rotor assy 3 (rotating portion).

The stator assy 2 is fixed to a base plate 4, and a sleeve fitting part 5 having a cylindrical shape is arranged at the central part of this base plate 4. At an outer circumference of the sleeve fitting part 5, a stator core 8 having stator coil 9 wound therearound is fitted and fixed.

The rotor assy 3 has a rotor hub 10, and this rotor hub 10 is fixed to an upper end of a shaft 11, and is rotatable together with the shaft 11. The shaft 11 is inserted inside of a sleeve 7 that is a bearing member, and the shaft 11 is rotatably supported by this sleeve 7. The sleeve 7 is fitted into the sleeve fitting part 5 and is fixed. At inner surface of a cylindrical part 14 of the rotor hub 10, a rotor magnet 13 is fixed and is magnetized with multiple N poles and S poles.

When voltage is applied to the stator coil 9, a magnetic field is generated by the stator core 8, and this magnetic field acts on the rotor magnet 13 so as to rotate the rotor assy 3. On outer circumferential surface of the cylindrical part 14 of the rotor hub 10 of the rotor assy 3, a disk placing part 10a projects to the outside along a radial direction, and a rotation disk, which is a recording part of the data recording device, for example, a magnetic disk (not shown), is attached thereto, and is rotated and halted by action of the spindle motor 1, so that information is written and read by a recording head (not shown).

In such a spindle motor 1, a fluid dynamic pressure bearing 6 is provided in the portion where the sleeve 7 rotatably supports the shaft 11.

At the lower end of the sleeve 7, a second concave part 16 having a larger diameter and opening toward the lower direction is formed, and at a top surface of the second concave part 16, a first concave part 15 having a smaller diameter is formed. A counter plate 17 is fitted to the second concave part 16 with larger diameter, and is then fixed thereto by a means such as welding or bonding, so that the lower end of the sleeve 7 is closed airtightly.

A flange part 18 is arranged at the lower end of the shaft 11, and this flange part 18 is placed in the first concave part 15 of the sleeve 7 to face the counter plate 17 and the top surface of the first concave part 15, so as to function as a retaining stopper of the shaft 11.

A gap between the outer circumferential surface of the sleeve 7 and the inner cylindrical part 22 of the rotor hub 10, a gap between the upper end surface of the sleeve 7 and the rotor hub 10, a gap between the sleeve 7 and the shaft 11, a gap between the flange part 18 and the first concave part 15, and a gap between the flange part 18 and the counter plate 17 are mutually in communication, and lubricating oil 12 is filled in these communicating gaps. The lubricating oil 12 is filled from the gap between the sleeve 7 and inner cylindrical part 22 of the rotor hub.

At the inner circumferential surface of the sleeve 7 facing the outer circumferential surface of the shaft 11, a first radial dynamic pressure groove 19 and a second radial dynamic pressure groove 20 for generating dynamic pressure are formed mutually separated along the axial direction. By rotation of the shaft 11, these radial dynamic pressure grooves 19 and 20 generate dynamic pressure in which the shaft 11 and the sleeve 7 become in a non-contact condition in the radial direction. A thrust dynamic pressure groove 21 is formed on an upper end surface of the sleeve 7. By the rotation of the shaft 11, the thrust dynamic pressure groove 21 generates dynamic pressure that floats the rotor assy 3 in the thrust direction. On the other hand, an attractive plate 23 having a ring shape attracts the rotor assy 3 downwardly in the thrust direction by magnetic action of the rotor magnet 13. By this mechanism, the position of floating becomes stable. By these actions of the dynamic pressure groove and the attractive plate, the rotor assy 3 can rotate stably at high speed and in a non-contact condition relative to the sleeve 7. As the dynamic pressure groove, well known patterns such as a herringbone groove, spiral groove or the like can be used.

### EXAMPLES

### 1. Preparation of Spindle Motor

### Example 1

A rotor hub made of the stainless steel (DHS1 material), was treated according to the process as shown in FIG. 3, i.e., after performing degreasing and desulfurizing, washing and acid activation treatments in this order, the rotor hub was immersed in electroless nickel plating tank in a condition in which surface liquid is simply removed without performing conventional washing process, so as to perform an electroless nickel plating treatment. As a result, the spindle motor of Example 1 having a surface structure with electroless nickel plating layer 102 directly formed on stainless steel 101, as shown in FIG. 1, was obtained.

### Example 2

Plating treatment was performed for a rotor hub in a manner similar to that in Example 1, except that the steps of degreasing, washing, acid electrolysis, and acid activation treatments were performed as shown in FIG. 4, instead of the steps of degreasing and desulfurizing, washing and acid activation treatments in Example 1. It should be noted that in the acid activation treatment of Example 2, the concentration of hydrochloric acid was lower than that in the acid electrolysis treatment of the process immediately before and that in the acid activation treatment of Example 1.

### Comparative Example 1

The spindle motor of Comparative Example 1 was produced in a manner similar to that in Example 1 except that electroless nickel plating of the rotor hub was not performed in the production process of the spindle motor.

### 2. Test for Evaluation

### (1) Measurement of Number of Particles by Particle Count

With respect to the rotor hub in the spindle motor of Examples 1 and 2 and Comparative Example 1 produced as mentioned above, the number of particles was measured as follows by the liquid particle count method which is a typical measurement method for evaluating particle generation. First, each of the rotor hubs was immersed in a container having ultrapure water and ultrasonic waves were applied to the entirety of the container for a predetermined period. Then, the number of particles in the ultrapure water was measured three times for each hub by a liquid particle counter. The results are shown in Table 1.

Thereafter, the ultrapure water to which ultrasonic waves were applied was filtered. Particles remaining on the filter were collected at random to analyze the elements of the particles by a Scanning Electron Microscope with Energy Dispersive X-ray Detector (SEM-EDX), and the number of particles was counted for each kind of identified metal. The results are shown in Tables 2 and 3.

TABLE 1

| | Measure- | Measure- | Measure- | Aver- |
|---|---|---|---|---|
| | ment 1 | ment 2 | ment 3 | age |
| Example 1 | 253,942 | 109,758 | 121,847 | 161,849 |
| Example 2 | 94,670 | 31,729 | 42,406 | 56,268 |
| C. Example 1 | 2,020,460 | 2,414,394 | 4,059,603 | 2,831,485 |

TABLE 2

Metallic particle

| | Fe—Cr—Mn | Fe | FeMn | FeNi | FeO |
|---|---|---|---|---|---|
| Example 1 | 0 | 7 | 0 | 4 | 12 |
| Example 2 | 0 | 8 | 0 | 4 | 0 |
| C. Example 1 | 5 | 8 | 4 | 0 | 164 |

TABLE 3

Mn Cr S particle

| | Measure- | Measure- | Measure- | Aver- |
|---|---|---|---|---|
| | ment 1 | ment 2 | ment 3 | age |
| Example 1 | 0 | 0 | 0 | 0 |
| Example 2 | 0 | 0 | 0 | 0 |
| C. Example 1 | 219 | 697 | 327 | 414 |

As shown in Tables 1 to 3, the number of particles in the rotor hub of Examples 1 and 2 of the present invention was reduced to about less than 1/10 and 1/20 respectively compared to the case of Comparative Example 1 which is a conventional product. This is because the machining-processed part is entirely covered with electroless nickel plating in Examples 1 and 2, thereby fixing fine particles that could scatter from the machining-processed part. Furthermore, particularly in Example 2, this is because the amount of treatment solution taken from the acid activation treatment, which is the previous process of electroless plating treatment, is reduced, thereby keeping the part surface cleaner and improving the efficiency of plating treatment. Thus, it was confirmed that the number of particles in the part made of stainless steel can be extremely reduced in the present invention by covering the machining processed part with metallic film so as to prevent the scattering of particles.

### (2) Bending Test

With respect to the rotor hub of the spindle motor of Examples 1 and 2 produced as mentioned above, according to a method of adhesion test for metallic coatings based on Japanese Industrial Standard (JIS) 8504, separation of nickel plating film was observed after repeating 3 times the following set of bending: 90 degree bending to one side, 90 degree bending to opposite side, and bend back to original state.

As a result, cracking and separating of plating at the bent portion were not observed for the rotor hubs of Examples 1 and 2 of the present invention. As explained thus far, electroless nickel plating film showing superior adhesion can be formed on the surface of the part made of stainless steel by using the present invention,

What is claimed is:

1. A spindle motor comprising:
a fixed portion; and
a rotating portion,
wherein at least a part of one of the fixed portion and the rotating portion is made of stainless steel, and a metallic film is directly formed on the surface of the stainless steel by electroless nickel plating.

2. The spindle motor according to claim 1, wherein the metallic film formed by the electroless nickel plating consists of one layer.

3. The spindle motor according to claim 1, wherein the metallic film formed by the electroless nickel plating contains phosphorus (P) or boron (B).

4. The spindle motor according to claim 1, wherein the metallic film formed by the electroless nickel plating is formed on at least one of a rotor hub and a shaft.

5. A hard disk drive comprising:
the spindle motor according to claim 1.

6. A method for producing a stainless steel part having electroless nickel plating on a surface thereof, at least comprising the steps of:
acid activation; and
electroless nickel plating,
wherein the electroless nickel plating step is performed subsequent to the acid activation step, without washing the part.

7. The method for producing a stainless steel part having electroless nickel plating on the surface thereof according to claim 6, wherein the method further comprises an acid electrolysis step before the acid activation step.

8. The method for producing a stainless steel part having electroless nickel plating on the surface thereof according to claim 7, wherein a concentration of an acid solution in the acid electrolysis step is higher than a concentration of acid solution in the subsequent acid activation step.
